(19) United States
(12) Patent Application Publication
(10) Pub. No.: US 2007/0266009 A1
(43) Pub. Date: Nov. 15, 2007

(54) Method for searching and retrieving information implementing a conceptual control

(76) Inventor: Frank John Williams, Los Alamitos, CA (US)

Correspondence Address: Frank John Williams, 2711 Saint Albaus Dr., Los Alamitos, CA, 90720, US

(21) Appl. No.: 11/716,314

(22) Filed: Mar. 8, 2007

Related U.S. Application Data
(60) Provisional application No. 60/780,743, filed on Mar. 9, 2006.
(60) Provisional application No. 60/782,893, filed on Mar. 16, 2006.
(60) Provisional application No. 60/783,476, filed on Mar. 18, 2006.

(51) Int. Cl. G06F 17/30

(52) U.S. Cl. 707/3

(57) ABSTRACT

A method and system controlling a search engine for producing synonyms and other conceptually relating words such as conclusive and deductive results by implementing a controlling information for modifying at least one of a query, search engine formulation, and source database for information.

### RELATED APPLICATIONS

This is application claims the benefit of: U.S. provisional patent application Ser. No. 60/780,743, filed Mar. 8, 2006, U.S. provisional patent application Ser. No. 60/782,893 filed Mar. 16, 2006 and U.S. provisional patent application Ser. No. 60/783,476 filed Mar. 18, 2006 by the present inventor.

### BACKGROUND

1. Field of the Invention

The present invention relates generally to a method for searching and retrieving information. More particularly, a novel method of implementing an information for controlling the number of synonyms, similarities and other relational words and conceptual interrelations when searching and/or retrieving information.

2. Description of Related Art

Because of the massive quantities of information the Internet has to offer, a series of new search engine technologies and methodologies have emerged. However, none of the present and intellectual envisioned technologies provides control to the magnitude and the spectrum of the relational words included in the search or retrieval operations. This is particularly important in synonym and similarity search engines; wherein the quantity of words searched or retrieved depends entirely on previously established association and not that by the user. For example, in U.S. Pat. No. 6,775,663 Kim Si Han, describes a search engine implementing identifiers to substitute the text to be searched upon; wherein said identifier represents the texts of several synonyms. In this method, the several words roofed by the identifier are determined by others and not the user, thus not permitting the user any control to manipulate how many words are to be included. In U.S. Pat. No. 6,480,843 Li discloses a search engine implementing several queries of all the synonyms that a word has from its initial query entry. Here too, the synonyms of the word are pre-established by an entity other than the user. In similar fashion, other methods such as expanding the databases of information to include all synonyms, or automatically expanding the user's query to include all synonyms, also fails to provide control to the user. Furthermore, additional conceptual relationships for other words exceeding the synonym spectrum, such as that provided by similarities, wherein words “gorgeous” and “cute” meaning beauty, absolutely differ in intensity, or other relations such as conclusive and deductive results allowing to associate “John was killed” with “John is dead” would have to be incorporated or completely ignored without giving the user any control or flexibility to decide.

In view of the present shortcomings, the present invention distinguishes over the prior art by providing heretofore a method to allow user to control the amount of associative information, while providing additional unknown, unsolved and unrecognized advantages as described in the following summary.

### SUMMARY OF THE INVENTION

The present invention teaches certain benefits in use and construction which give rise to the objectives and advantages described below. The methods embodied by the present invention overcome the limitations and shortcomings encountered by synonym capable search engines, while suggestively expands their retrieval information range and organizes their results. The method comprises providing an information, here introduced as a “controlling information” for allowing the user to have control or controlling the amount or type of information that is to be searched or retrieved by a search engine, such as controlling the number of synonyms included on a particular search, while it also provides the ability to include or remove other conceptual associative words such as similarities, conclusive words and concepts, and deductive words and concepts. The user is given control to the associations that are ultimately considered by the search engine based upon the query's content. The method involves access to different relational word databases upon the user's criterion (controlling information).

implementing a controlling information for providing control to a user for controlling the amount and/or type of information that is to be searched or is retrieved

### OBJECTS AND ADVANTAGES

A primary objective inherent in the above described method of use is to provide a method for controlling identical, similar, deductive and conclusive information to be retrieved by a search engine not taught by the prior arts and further advantages and objectives not taught by the prior art. Accordingly, additional objectives and advantages of the invention are

Another objective is to safeguard user's time.

Another objective is to permit searching of information into other languages as imply by each user.

A further objective is to permit to organize the results generated by a search engine when a word in the query has several synonyms.

A further objective is to permit the search and retrieval of conclusive and/or deductive results.

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate examples of at least one of the best mode embodiments of the present method of use. In such drawings:

FIG. 1 illustrates a block diagram of the basic steps of the disclosed inventive method;

FIG. 2a and 2b illustrate a non-limiting view of a search engine's client interface for finding conclusive and/or deductive results, and a block diagram of the inventive method for finding said conclusive and/or deductive results.

FIGS. 3A, FIG. 3B and FIG. 3C all illustrate non-limiting searches or search engine formulations based on a controlling additive information;

FIG. 4 illustrates conclusive and deductive results of a search operation;

FIG. 5 illustrates a synonym search engine controlled by a controlling information based on points;

FIG. 6 depicts a search engine of identifier;

FIG. 7 illustrates a further word example of a search engine using identifiers;

### DETAILED DESCRIPTION

The above described drawing figures illustrate the described methods and use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present system and method of use.

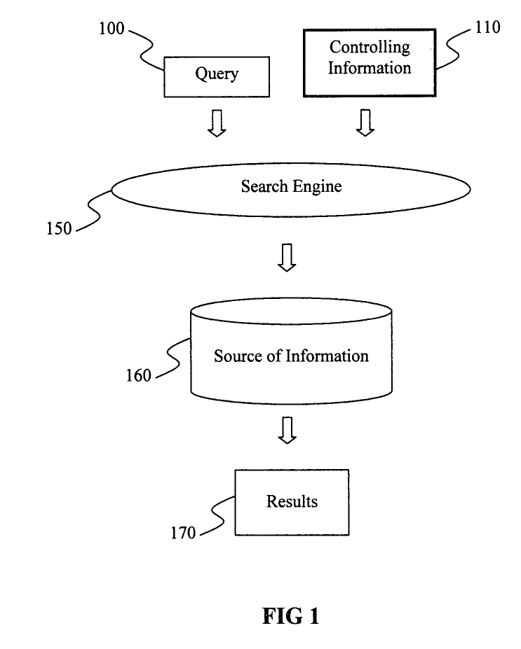

FIG. 1 shows an exemplary block diagram of the basic inventive method. The obvious query 100 (FIG. 1) and new Controlling Information 110 (FIG. 1) affect the search engine 150 (FIG. 1) which performs searching and retrieving operations on the source for information 160 (FIG. 1) for providing the Results 170 (FIG. 1).

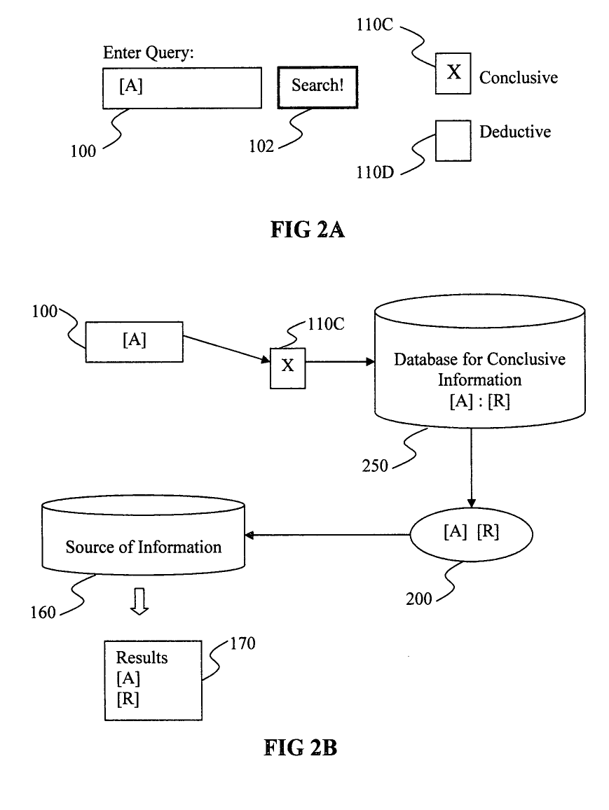

FIG. 2a and 2b illustrate a non-limiting view of a prospective search engine's interface for finding conclusive and/or deductive results, and a block diagram of a variation of the inventive method for finding said conclusive and/or deductive results. FIG. 2A illustrates the obvious query entry field 100 (FIG. 2A) containing an entry word [A] to be searched, and the obvious search command 102 (FIG. 2A) to commence the search. It also illustrates the controlling information entry for conclusive results 110C (FIG. 2A) which is activated for including conclusive results in the search as indicated by the letter “X”, and the controlling information for deductive results 110D (FIG. 2A) which is not active, thus avoiding deductive result in the search and/or retrieval operations. FIG. 2B illustrates the steps involved in one variation of the inventive method. The query 100 (FIG. 2B) comprises the word [A] for searching. The controlling information 110C (FIG. 2B) permits access (because is activated) to the database for conclusive information 250 (FIG. 2B) which is used to identify a conclusive word [R] associated to the word [A]. Then, the search and retrieval operation 200 (FIG. 2B) is formulated to include the words [A] and [R]; which are searched and retrieved from the source of information 160 (FIG. 2B) for producing the results 170 (FIG. 2B) comprising the word [A] and a conclusive word [R].

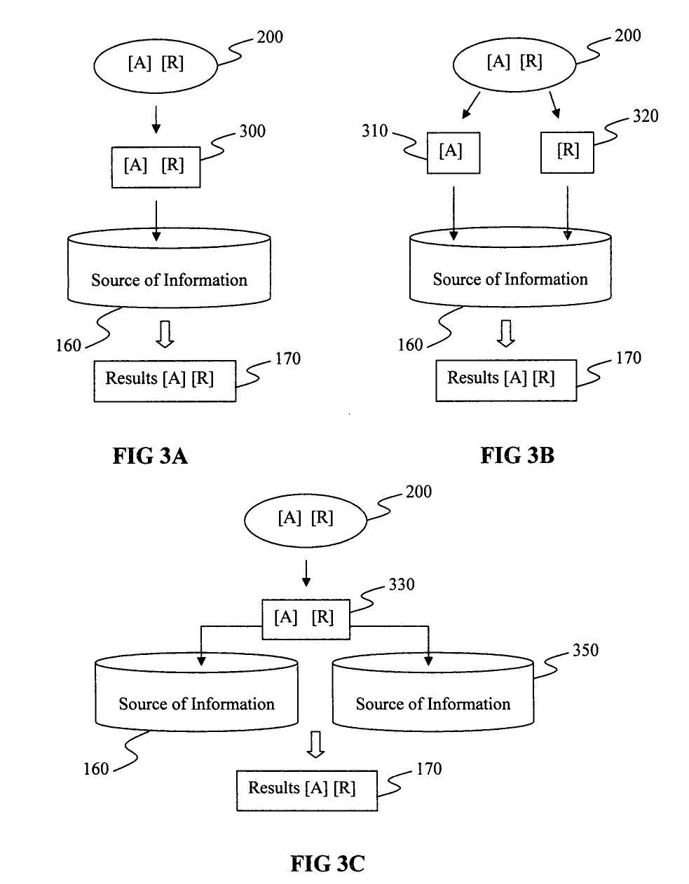

FIG. 3A, FIG. 3b and FIG. 3C all illustrate search engines or search engine's formulations for searching and/or retrieving information based on controlling information. In FIG. 3A the search engine 200 (FIG. 3A) expands the query to include the words [A] and [R] implementing “or” function; that is searching and retrieving information comprising the word [A] or comprising the word [R]. The source of information 160 (FIG. 3A) is searched thus producing the results 170 (FIG. 3A) wherein the words [A] and/or [R] are included. In FIG. 3B the search formulation involves creating two searches or queries 310 (FIG. 3B) and 320 (FIG. 3B). Also, in identical fashion, is to add a second search 320 (FIG. 3B) comprising the conclusive word [R] to the initial search 310 (FIG. 3B) which ultimately produces the same search behavior. For either case, the source of information 160 (FIG. 2B) is used to find the results 170 (FIG. 2B) wherein the words [A] and/or [R] are present. In FIG. 3C the search formulation 200 (FIG. 3C) now involves implementing a query 330 (FIG. 3C) and accessing or adding an additional source of information 350 (FIG. 3C) for searching and thus retrieving the results 170 (FIG. 3C) which again include the original word [A] and/or its conclusive word partner [R].

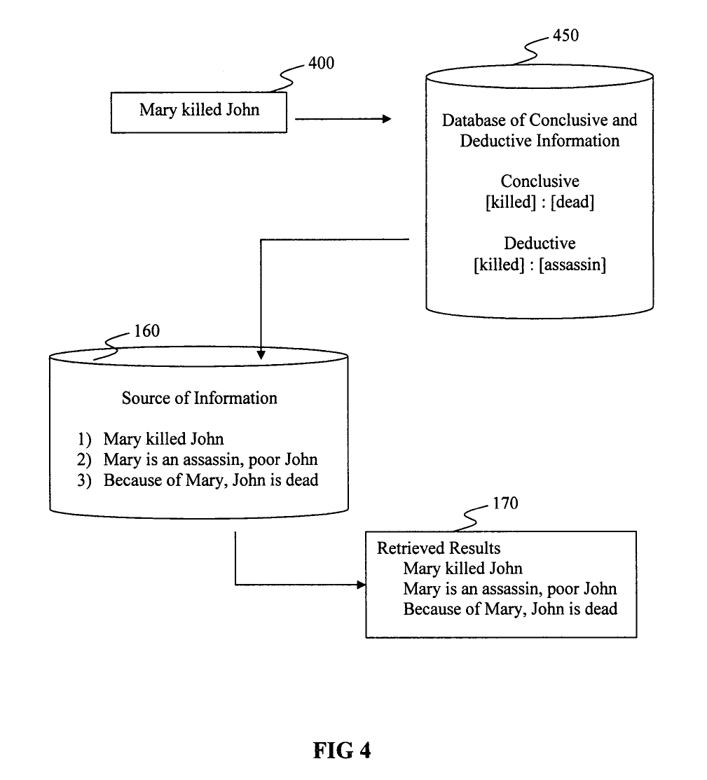

FIG. 4 illustrates an example query of “Mary killed John” and conclusive and deductive results. The query 400 (FIG. 4) (or search engine) is modified by the database of conclusive and deductive information 450 (FIG. 4) for searching and retrieving information from the source for information 160 (FIG. 4), wherein the records the first record “Mary killed John” 161 (FIG. 4), the second record “Mary is an assassin, poor John” 162 (FIG. 4), and the third record “Because of Mary, John is dead” 163 (FIG. 4) are present. The conclusive and deductive database 450 (FIG. 4) associates the word [killed] with the words [assassin] and [dead]. Therefore, the search engine is now capable of searching and retrieving information wherein the words [Mary], [John], [killed], [assassin] and [dead] are present; with the condition that [Mary] and [John] are contained; thus retrieving the records 170 (FIG. 4) comprising the phrases “Mary killed John,” “Mary is an assassin, poor John,” and “Because of Mary, John is dead.”

In almost an identical fashion to the disclosed, additional synonyms or other conceptually relating words could be added to a search, query or results. But also, implementing the idea or the behavior of using controlling information, synonyms or other words could also be removed or discriminated, based upon the search engine and its formulations, such as the following examples illustrated in FIGS. 5, 6 and 7.

FIG. 5 illustrates a synonym search engine that is controlled by a controlling information based on points or “point controlling information” 555 (FIG. 5). In this example, the associations that the search engine accesses for retrieving information are linked or identified by said “point controlling information.” For example, the query 500 (FIG. 5) is executed based upon the point information 555 (FIG. 5); which is also identified or present in the column 555a (FIG. 5) of the table 520 (FIG. 5) for comprising or including the words 555b (FIG. 5). In such fashion, when a user enters a word [dog] and enters or selects the number “1” in the controlling point information 555 (FIG. 5), the search engine will use the words [dog], and [canine] in the search. In similar fashion, when a user once again enters the word [dog] and uses the number “2” in the controlling information, the search engine will utilize the words [dog], [canine] and in addition the word [k-9] as depicted by the table 520 (FIG. 5). Please note that suggestively, a point equal to “0” implies that the search engine will only retrieve results comprising the exact words as entered in the query.

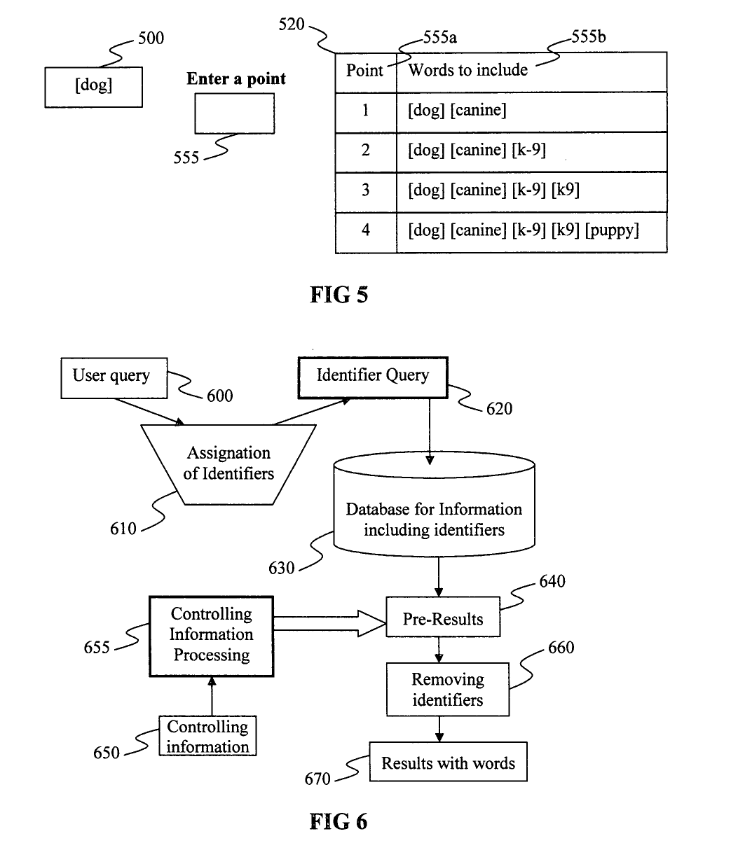

FIG. 6 illustrates a non-limiting block diagram of an opposite search engine as the one depicted in FIG. 5. The search engine of FIG. 6 implements “group identifiers” or information capable of identifying several words simultaneously. In such fashion, the query of [dog] is converted to an identifier which includes several synonyms of the word [dog], thus retrieving all synonyms included by such identifier. In FIG. 6 the user's query 600 (FIG. 6) is converted to a query comprising identifiers 620 (FIG. 6) thanks to an assigning identifiers process 610 (FIG. 6). Then search is executed implementing the identifiers of the query 620 (FIG. 6) upon a database of information 630 (FIG. 6) also comprising of identifiers. In this example, the results of such a search here named “pre-results” 640 (FIG. 6) are later distilled or selected based upon a controlling information 650 (FIG. 6). FIG. 6 also depicts the optional or additional step of processing the controlling information 655 (FIG. 6) for distilling or selecting the pre-results 640 (FIG. 6). FIG. 6 also illustrates the optional step removing and/or substituting the identifiers 660 (FIG. 6) with actual words and the final step of presenting the results 670 (FIG. 6).

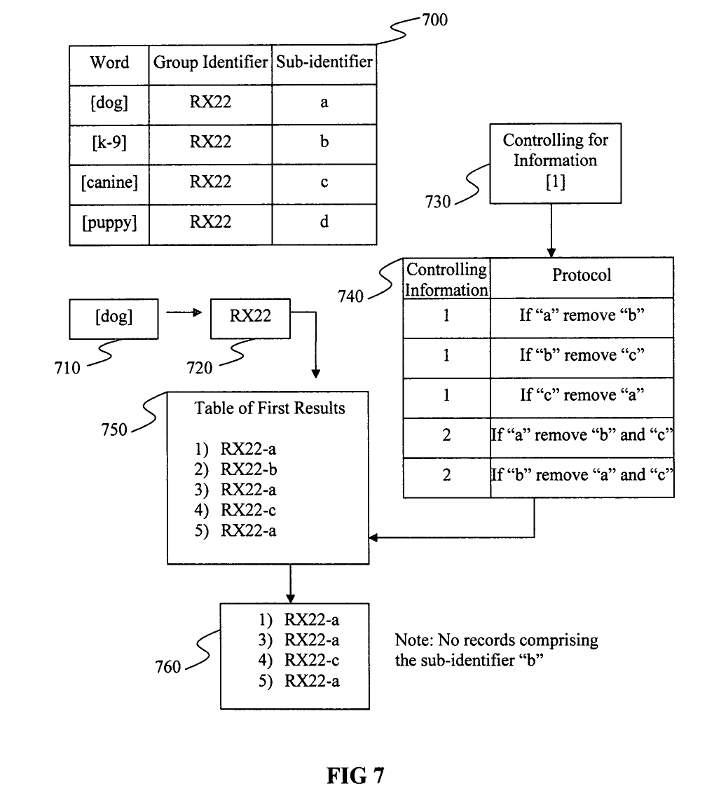

FIG. 7 further illustrates an example of identifiers and the processing of controlling information mentioned in FIG. 6 for controlling the results generated by the search engine. In FIG. 7 table 700 (FIG. 7) illustrates the synonyms of the word [dog] being identified by a group identifier RX22 and a sub identifier (a through d). As mentioned in FIG. 6, the first query of [dog] 710 (FIG. 7) is converted to the second query of identifiers RX22 720 (FIG. 7) for performing a search that generates the results of table 750 (FIG. 7) comprising a total of five records still implementing identifiers. The controlling information 730 (FIG. 7) is processed according to the processing table 740 (FIG. 7). The table 740 (FIG. 7) depicts a series of controlling processing based upon the controlling information. For example, when the controlling information is 1, and the word's sub-identifier is [a], then the sub-identifier [b] are removed from the records. In similar fashion, when the controlling information is 2, and the word's sub-identifier is [a], then remove the sub-identifiers [b] and [c]. In this fashion, records from the table 750 (FIG. 7) can be distilled to incorporate only some results for providing a final record or set of records 760 (FIG. 7) to a user.

FIG. 7 illustrates a temporary user's lexicon which is applied to a database for searching and retrieving information. For example, information and a

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a novel method of searching for information can be appreciated. The described method overcomes the limitations encountered by synonym and grouping search engines by implementing a controlling information for providing control to a user for controlling the amount and/or type of information that is to be searched or is retrieved.

1. A method for searching and retrieving meaning element information, the method comprising the steps of:
a) Providing a search engine;
b) Providing an information for controlling results;
c) Implementing said information for controlling results for modifying at least one of a: searching operation, retrieval operation, and displaying operation;
d) Providing results modified by said information for controlling results.
